(19) United States
(12) Patent Application Publication
(10) Pub. No.: US 2019/0383441 A1
(43) Pub. Date: Dec. 19, 2019

(54) METAL HANGER SYSTEM FOR VERTICAL APPLICATIONS

(71) Applicants: Mechele B. Cummins, Tallahassee, FL (US); Damon L. Cummins, SR., Tallahassee, FL (US)

(72) Inventors: Mechele B. Cummins, Tallahassee, FL (US); Damon L. Cummins, SR., Tallahassee, FL (US)

(21) Appl. No.: 16/006,996

(22) Filed: Jun. 13, 2018

(51) Int. Cl. F16M 13/02; A47G 7/04; F16B 45/00; A47B 61/00; G09F 17/00; G09F 7/18; A47K 10/04

(52) U.S. Cl. CPC F16M 13/022; A47G 7/045; F16B 45/00; G09F 2007/1804; G09F 17/00; G09F 7/18; A47K 10/04; A47B 61/003

(57) ABSTRACT

A post is vertically oriented and has upward and downward extents, back and front regions, and inner and outer regions. A load is configured for functional purposes. A support assembly couples the post and the load. The support assembly has interior and exterior sections and an intermediate section there between. The interior section has an inner leg in contact with the inner region of the post. The interior section has an outer leg in contact with the outer region of the post. The interior section has a front leg in contact with the inner region of the post. The back region of the post is out of contact with the interior section of the support assembly. The exterior section of the support assembly is out of contact with post.

### BACKGROUND OF THE INVENTION

### Field of the Invention

The present invention relates to a metal hanger system for vertical applications and more particularly pertains to removably supporting a load from a post and readily varying both the load and the post in a safe, convenient, and economical manner.

### Description of the Prior Art

The use of hanger systems of known designs and configurations is known in the prior art. More specifically, hanger systems of known designs and configurations previously devised and utilized for the purpose of removably supporting a load from a post are known to consist basically of familiar, expected, and obvious structural configurations, notwithstanding the myriad of designs encompassed by the crowded prior art which has been developed for the fulfillment of countless objectives and requirements.

While these devices fulfill their respective, particular objectives and requirements, they do not describe a metal hanger system for vertical applications that allows removably supporting a load from a post and readily varying both the load and the post in a safe, convenient, and economical manner.

In this respect, the metal hanger system for vertical applications according to the present invention substantially departs from the conventional concepts and designs of the prior art, and in doing so provides an apparatus primarily developed for the purpose of removably supporting a load from a post and readily varying both the load and the post in a safe, convenient, and economical manner.

Therefore, it can be appreciated that there exists a continuing need for a new and improved metal hanger system for vertical applications which can be used for removably supporting a load from a post and readily varying both the load and the post in a safe, convenient, and economical manner. In this regard, the present invention substantially fulfills this need.

### SUMMARY OF THE INVENTION

In view of the disadvantages inherent in the known types of hanger systems of known designs and configurations now present in the prior art, the present invention provides an improved metal hanger system for vertical applications. As such, the general purpose of the present invention, which will be described subsequently in greater detail, is to provide a new and improved metal hanger system for vertical applications and method which has all the advantages of the prior art and none of the disadvantages.

To attain this, from a broad perspective, the present invention essentially comprises a vertically oriented post with downward extents, back and front regions, and inner and outer regions. A load is configured for functional purposes. A support assembly couples the post and the load. The support assembly has interior and exterior sections and an intermediate section there between. The interior section has an inner leg in contact with the inner region of the post. The interior section has an outer leg in contact with the outer region of the post. The interior section has a front leg in contact with the inner region of the post. The back region of the post is out of contact with the interior section of the support assembly. The exterior section of the support assembly is out of contact with post.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved metal hanger system for vertical applications which has all of the advantages of the prior art hanger systems of known designs and configurations and none of the disadvantages.

It is another object of the present invention to provide a new and improved metal hanger system for vertical applications which may be easily and efficiently manufactured and marketed.

It is a further object of the present invention to provide a new and improved metal hanger system for vertical applications which is of durable and reliable constructions.

An even further object of the present invention is to provide a new and improved metal hanger system for vertical applications which is susceptible of a low cost of manufacture with regard to both materials and labor, and which accordingly is then susceptible of low prices of sale to the consuming public, thereby making such metal hanger system for vertical applications economically available to the buying public.

Lastly, it is an object of the present invention to provide a metal hanger system for vertical applications for removably supporting a load from a post and readily varying both the load and the post in a safe, convenient, and economical manner.

These together with other objects of the invention, along with the various features of novelty which characterize the invention, are pointed out with particularity in the claims annexed to and forming a part of this disclosure.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a side elevational view of a metal hanger system for vertical applications constructed in accordance with the principles of the present invention.

FIG. 2 is a plan view taken along line 2-2 of FIG. 1.

FIG. 3 is a side elevational view taken along line 3-3 of FIG. 1.

FIG. 4 is a front elevational view of a multi-clip suspension system constructed in accordance with a first alternate embodiment of the invention.

FIG. 5 is a plan view taken along line 5-5 of FIG. 4.

FIG. 6 is a side elevational view taken along line 6-6 FIG. 4.

FIG. 7 is an enlarged showing taken at circle 7 of FIG. 4.

FIG. 8 is a perspective showing of a second alternate embodiment of the invention for use in supporting a bowl or the like from below.

FIG. 9 is a perspective showing of a third alternate embodiment of the invention for use in providing a profile of an animal, pet, or the like.

FIG. 10 is a perspective showing of a fourth alternate embodiment of the invention for use in supporting swimming towels, items of apparel, or the like.

FIG. 11 is a perspective showing of a fifth alternate embodiment of the invention for use in supporting a flagpole or the like.

FIG. 12 is a perspective showing of a sixth alternate embodiment of the invention for use in laterally supporting signs or the like.

FIG. 13 is a perspective showing of an eighth alternate embodiment of the invention for use in supporting a ring or the like.

FIG. 14 is a perspective showing of a ninth alternate embodiment of the invention for use in supporting an envelope with sheets of literature or the like.

FIG. 15 is a perspective showing of a tenth alternate embodiment of the invention for use in displaying a Valentines Day heart or like symbols.

FIG. 16 is an exploded perspective view of a Valentines Day heart of FIG. 15.

FIG. 17 perspective showing of the shroud of FIG. 15.

FIG. 18 is a perspective showing of a double support assembly in use.

FIG. 19 is a perspective showing of the double support assembly prior to use.

FIG. 20 is a plan view taken along line 20-20 of FIG. 19.

FIG. 21 is a perspective showing of interior section of the double support assembly.

FIG. 22 is a perspective showing of the exterior section of the double support assembly.

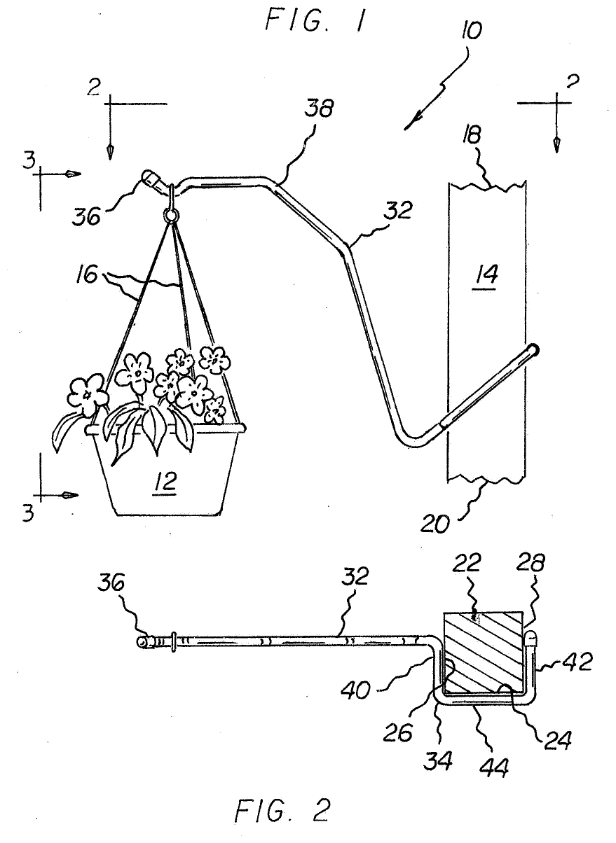

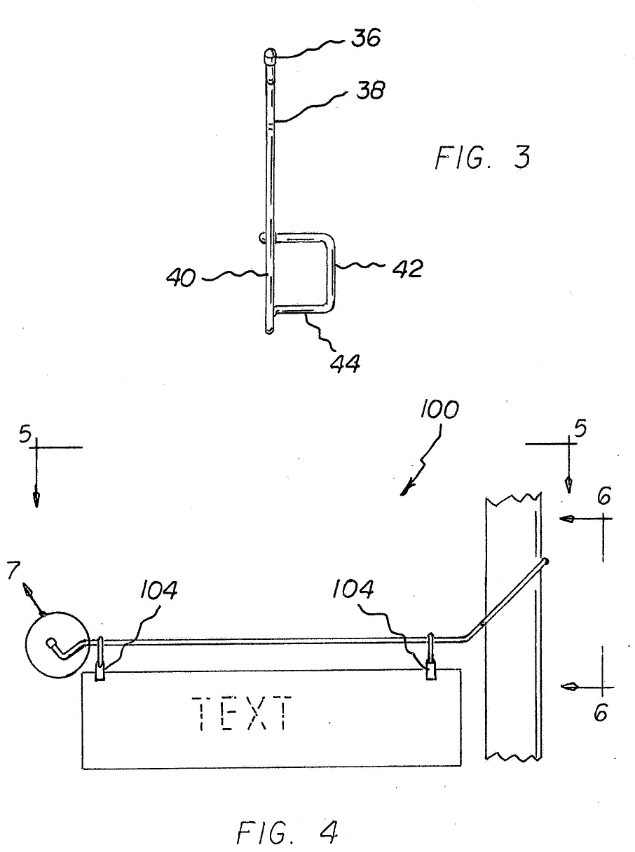

The same reference numerals refer to the same parts throughout the various Figures.

### DESCRIPTION OF THE PREFERRED EMBODIMENT

With reference now to the drawings, and in particular to FIG. 1 thereof, the preferred embodiment of the new and improved metal hanger system for vertical applications embodying the principles and concepts of the present invention and generally designated by the reference numeral 10 will be described.

The present invention, the metal hanger system for vertical applications 10 is comprised of a plurality of components. Such components in their broadest context include a post, a load, and a support assembly. Such components are individually configured and correlated with respect to each other so as to attain the desired objective.

From a specific perspective, the invention of the present application is a metal hanger system 10 for vertical applications for removably supporting a load 12 from a post 14 and for readily varying both the load and the post. The supporting and the varying are done in a safe, convenient, and economical manner.

The post 14 is first provided. The post is vertically oriented and has an upward extent 18, a downward extent 20, a back region 22, a front region 24, an inner region 26, and an outer region 28.

Next provided is the load 12. The load is supported by a plurality of cords 16 and configured for functional purposes.

Finally, a support assembly 32 is provided. The support assembly couples the post and the load. The support assembly has an interior section 34, an exterior section terminating with an end cap 36, and an intermediate section 38 between the interior section and the exterior section. The interior section has an inner leg 40 in contact with the inner region of the post. The interior section has an outer leg 42 in contact with the outer region. The interior section has a front leg 44 in contact with the inner region of the post. The back region of the post is out of contact with the support assembly.

The support assembly is fabricated of cold rolled steel wire with a diameter of from 0.25 inches to 0.50 inches. The front leg has a length of from 2.0 inches to 10.0 inches. The inner leg has a length of from 25 percent to 75 percent of the length of the front leg. The outer leg has a length of from 25 percent to 75 percent of the length of the front leg. The support assembly has a length of at least twice the length of the front leg.

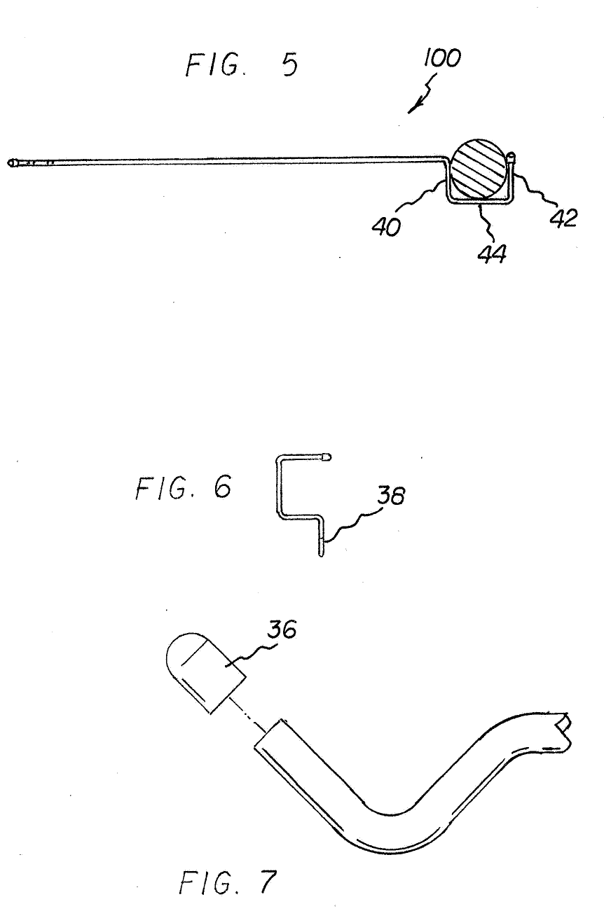

An alternate embodiment of the system 100 is shown in FIGS. 4 and 5. In this embodiment, a plurality of clips 104 are provided between the load and the support assembly.

In another alternate embodiment of the system 200 is shown in FIG. 8. In this embodiment a circular receptor 204 is formed in the support assembly.

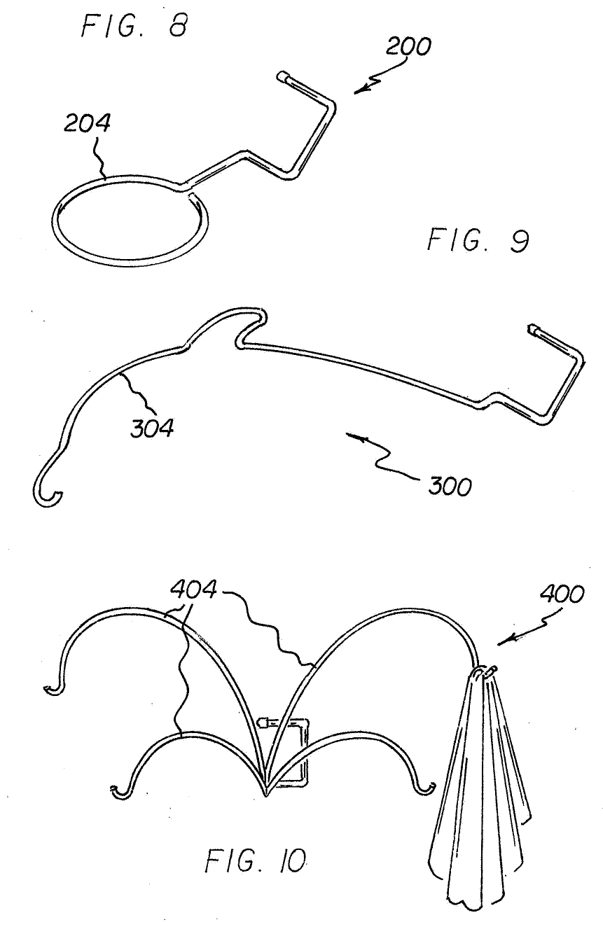

Another embodiment of the system 300 is shown in FIG. 9. In this embodiment, the load is a silhouette 304 formed in the upper assembly. The existing form extending from the U-shape can be shaped into any known and unknown silhouettes, either via the round rod steel or other fabricated substances, or by using flat, cutout methods that have been attached either by welding or bluing, depending upon the material being used. Silhouette forms may be animal, machinery, water dwelling creatures, birds, people, toys, or anything that the user chooses to utilize to create the desired look.

FIG. 10 shows another alternate embodiment of the system 400. In this embodiment, the load is a fabric tower/garment 404 and the support assembly is a plurality of rods each in an inverted J-shaped configuration.

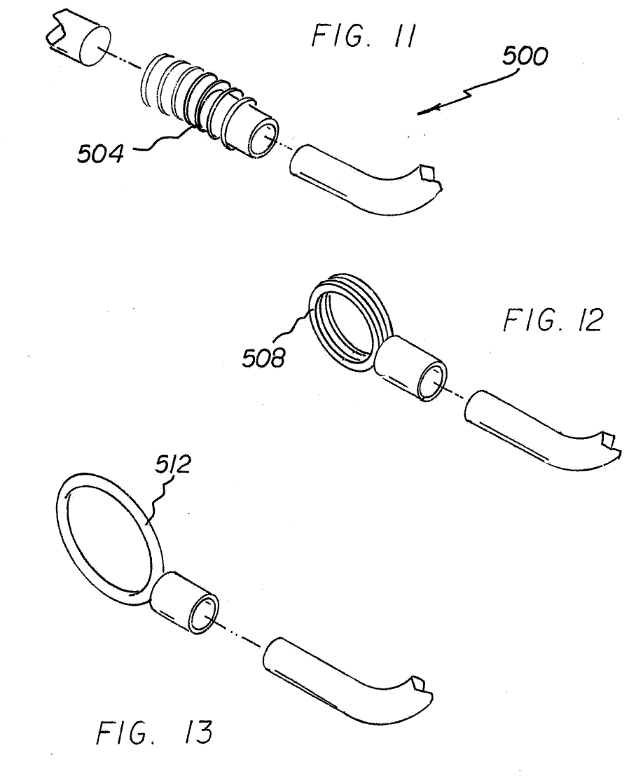

Another alternate embodiment of the system 500 is shown in FIGS. 11, 12, and 13. In this embodiment further included are strengthening ribs 504 on the support assembly for supporting a flag. A plurality of circular rings 508 are closely spaced axially on the support assembly for supporting papers. A circular ring 512 is formed in the support assembly for supporting a towel/garment.

In another alternate embodiment of the system 600, shown in FIG. 14, further included is a cylindrical container 604 separately coupled to the support assembly for supporting a paper work for real estate purposes.

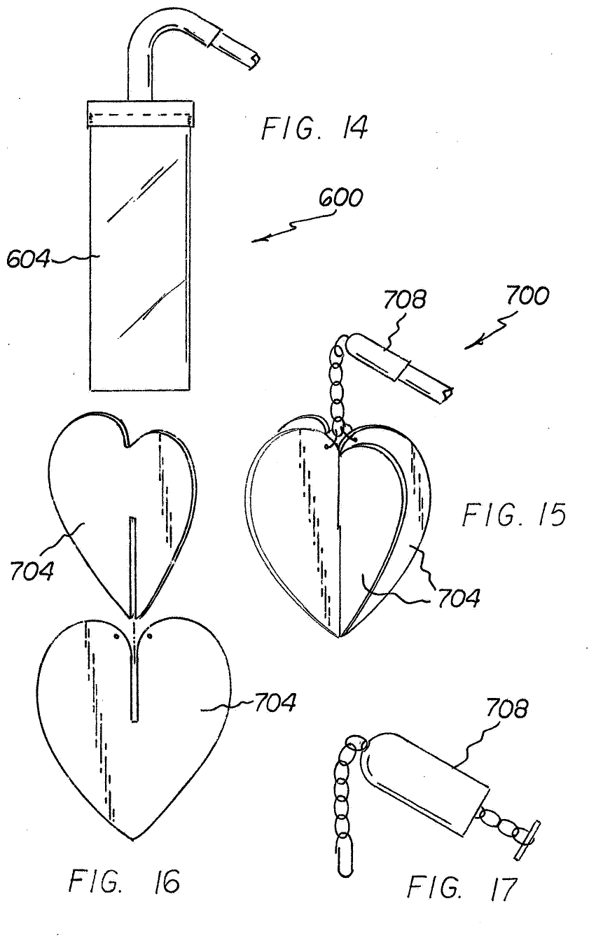

Another alternate embodiment of the system 700 is shown in FIGS. 15, 16, and 17. In this embodiment further included are two heart shaped cut-outs 704 coupled to the support assembly. A shroud 708 is slidably positioned over an interface between the load and the support assembly.

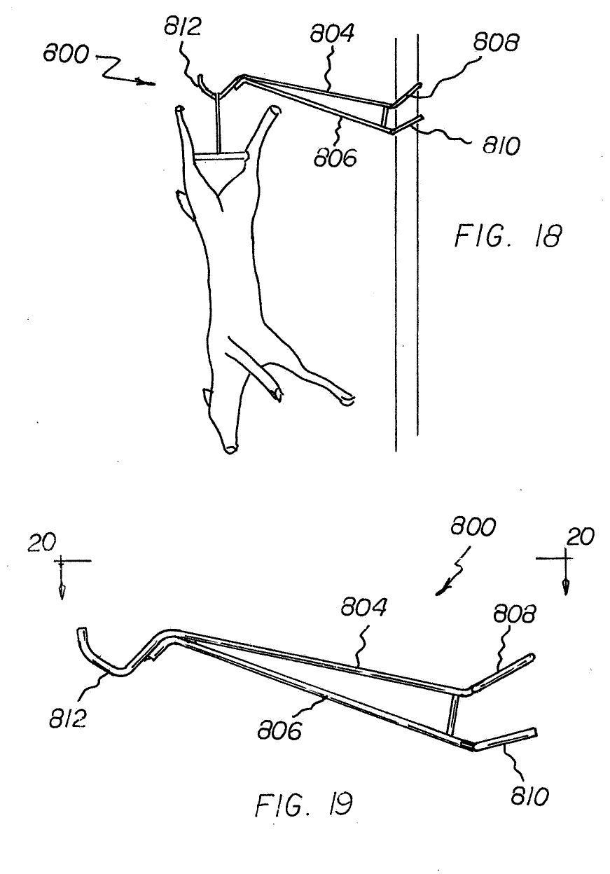

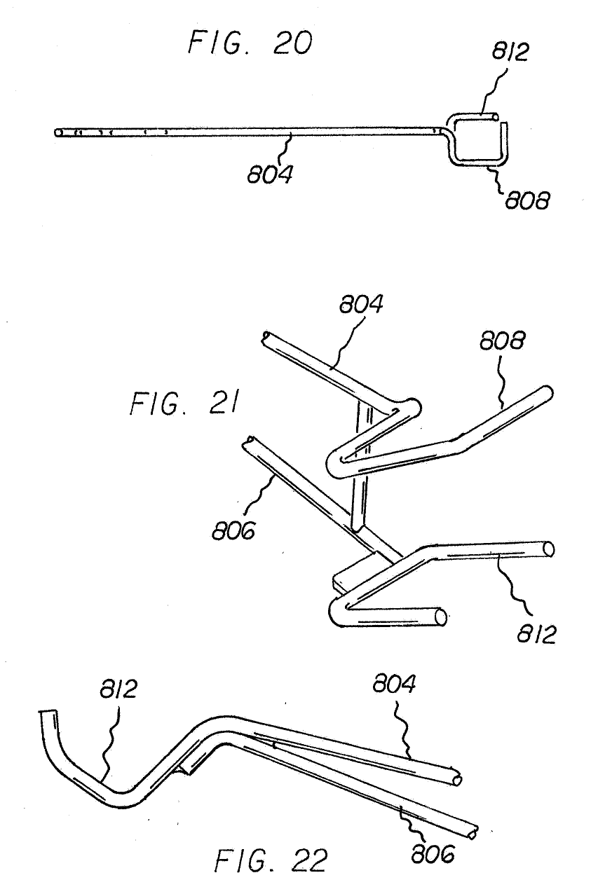

A final alternate embodiment of the system 800 is shown in FIGS. 18 through 22. In this embodiment the support assembly includes a primary rod 804 and a secondary rod 806, a primary C-shaped member 808 and a secondary C-shaped member 810, and a single exterior hook 812 for heavier loads to be supported, such as game from hunting.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A hanger system comprising:
a post being vertically oriented and having upward and downward extents, the post having back and front regions, the post having inner and outer regions;
a load being configured for functional purposes;
a support assembly coupling the post and the load, the support assembly having interior and exterior sections and an intermediate section there between, the interior section having an inner leg in contact with the inner region of the post, the interior section having an outer leg in contact with the outer region of the post, the interior section having a front leg in contact with the inner region of the post, the back region of the post being out of contact with the interior section of the support assembly, the exterior section of the support assembly being out of contact with post.

2. The system (10) as set forth in claim 1 and further including a plurality of cords (14) between the load and the support assembly, the support assembly terminating in an end cap.

3. The system (100) as set forth in claim 1 and further including a plurality of clips (104) between the load and the support assembly.

4. The system (200) as set forth in claim 1 and further including a circular receptor (204) formed in the support assembly.

5. The system (300) as set forth in claim 1 wherein the load is a silhouette (304) formed in the upper assembly. (In the specification, not the claims, type in the inventor comments)

6. The system (400) as set forth in claim 1 wherein the load is a fabric tower/garment (404) and the support assembly is a plurality of rods each in an inverted J-shaped configuration.

7. The system (500) as set forth in claim 1 and further including strengthening ribs (504) on the support assembly for supporting a flag.

8. The system as set forth in claim 1 and further including a plurality of circular rings (508) closely spaced axially on the support assembly for supporting papers.

9. The system as set forth in claim 1 and further including a circular ring (512) formed in the support assembly for supporting a towel/garment.

10. The system (600) as set forth in claim 1 and further including a cylindrical container (604) separately coupled to the support assembly for supporting a paper work for real estate purposes.

11. The system (700) as set forth in claim 1 and further including two heart shaped cut-outs (704) coupled to the support assembly, the system further including a shroud (708) slidably positioned over an interface between the load and the support assembly.

12. The system (800) as set forth in claim 1 wherein the support assembly includes a primary rod (804) and a secondary rod (806), and a primary C-shaped member (808) and a secondary C-shaped member (810), and a single exterior hook (812) for heavier loads to be supported, such as game from hunting.

13. A metal hanger system (10) for vertical applications for removably supporting a load (12) from a post (14) and for readily varying both the load and the post, the system comprising, in combination:
the post (14) being vertically oriented and having an upward extent (18) and a downward extent (20), the post having a back region (22), a front region (24), an inner region (26), and an outer region (28);
the load (12) being supported by a plurality of cords (16) and configured for functional purposes; and
a support assembly (32) coupling the post and the load, the support assembly having an interior section (34) and an exterior section (36) and an intermediate section (38) there between, the interior section having an inner leg (40) in contact with the inner region of the post, the interior section having an outer leg (42) in contact with the outer region, the interior section having a front leg (44) in contact with the inner region of the post, the back region of the post being out of contact with the support assembly;
the support assembly being fabricated of cold rolled steel wire with a diameter of from 0.25 inches to 0.50 inches, the front leg having a length of from 2.0 inches to 10.0 inches, the inner leg having a length of from 25 percent to 75 percent of the length of the front leg, the outer leg having a length of from 25 percent to 75 percent of the length of the front leg, the support assembly having a length of at least twice the length of the front leg.
